(19) United States
(12) Patent Application Publication
(10) Pub. No.: US 2010/0151843 A1
(43) Pub. Date: Jun. 17, 2010

(54) Transmission Of Contact Information About An Initiating Communication Partner To A Receiving Communication Partner In The Course Of A Call

(76) Inventors: Michael Brecht, Dusseldorf (DE); Evgeniya Altareva, Dusseldorf (DE); Jan Holzberg, Dusseldorf (DE)

Correspondence Address: ST. ONGE STEWARD JOHNSTON & REENS, LLC, 986 BEDFORD STREET, STAMFORD, CT, 06905-5619, US

(21) Appl. No.: 12/635,938

(22) Filed: Dec. 11, 2009

Related U.S. Application Data
(63) Continuation of application No. PCT/EP2008/003547, filed on May 2, 2008.

(30) Foreign Application Priority Data
Jun. 11, 2007 (DE) 102007027379.9

(51) Int. Cl. H04M 3/42

(52) U.S. Cl. 455/415; 455/414.1

(57) ABSTRACT

A method for the at least partially automatic determination of contact information of at least one communication partner in the context of a communication connection between at least two communication partners in a communication network is proposed, wherein at least one contact information of the communication partner initiating the communication connection is communicated to the at least one receiving communication partner. The at least one contact information is predetermined by the communication partner initiating the communication connection. Furthermore, a terminal for the use in a communication network is provided, preferably a mobile network according to a GSM, GPRS and/or UMTS radio network standard, which terminal is designed and/or adapted to at least partially carry out the method. Furthermore, a network node in a communication network is provided, preferably a mobile network according to a GSM, GPRS and/or UMTS radio network standard, which node at least contributes to the establishment, the holding and/or the disconnection of the communication connection.

### CROSS-REFERENCE TO RELATED APPLICATIONS

The present application is a continuation of pending International patent application PCT/EP2008/003547 filed on May 2, 2008 which designates the United States and claims priority from German patent application 10 2007 027 379.9 filed on Jun. 11, 2007, the content of which is incorporated herein by reference.

### FIELD OF THE INVENTION

The present invention relates to a method for the at least partially automatic determination of contact information of at least one communication partner in the context of a communication connection between at least two communication partners in a communication network, wherein at least one contact information of the communication partner initiating the communication connection is communicated to the at least one receiving communication partner.

### BACKGROUND OF THE INVENTION

Furthermore, the present invention relates to a terminal for the use in a communication network, preferably a mobile network according to a GSM, GPRS and/or UMTS radio network standard, which terminal is designed and/or adapted to at least partially carry out a method according to the invention

Furthermore, a subject of the invention is also a network node in a communication network, preferably a mobile network according to a GSM, GPRS and/or UMTS radio network standard, which node at least contributes to the establishment, the holding and/or the disconnection of the communication connection and is designed and/or adapted to at least partially carry out a method according to the invention.

In the state of the art the use of contact information of communication partners in connection with switching features of performance of telecommunication networks, in particular digital telecommunication networks according to an ISDN standard and/or mobile networks according to a GSM, GPRS and/or UMTS radio network standard is known (cf. for example DE 198 30 716 A1 or DE 600 11 116 T2). Herein, the contact information is in particular used for identifying the phone number, for example in connection with the so called CLIP (CLIP: Calling Line Identification Presentation), CLIR (CLIR: Calling Line Identification Restriction), COLP (COLP: Connected Line Identification Presentation), COLR (COLR: Connected Line Identification Restriction) and/or like switching features of performance.

Herein, the hitherto existing limitations with respect to the type and volume as well as with respect to the individualized use of the contact information present a drawback, since this one has been essentially limited hitherto to the transmission and reproduction of the phone numbers of the communication partners.

Based upon this state of the art it is the object of the invention to improve the use of contact information of communication partners in communication networks, in particular with respect to the way and extend of use of contact information of communication partners.

This above mentioned aim is technically achieved by the present invention in that a method for the at least partially automatic determination of contact information of at least one communication partner in the context of a communication connection between at least two communication partners in a communication network is proposed, wherein at least one contact information of the communication partner initiating the communication connection is communicated to the at least one receiving communication partner, the method being characterized in that the at least one contact information is predetermined by the communication partner initiating the communication connection.

### SUMMARY OF THE INVENTION

The invention is based upon the knowledge that the possibility to predetermine the at least one contact information by the communication partner initiating a communication connection permits to achieve an improved use of the contact information, which use can be in particular individualized.

Advantageously, the at least one contact information of the communication partner initiating the communication connection will be managed by a data base gathering contact information. Advantageously, the data base is provided by a switching device of the communication network that contributes to the communication connection and/or is involved in the communication connection and/or by a terminal used by the communication partners for the communication connection and usable in the communication network.

Another advantageous embodiment of the invention provides that the at least one contact information will be communicated to the at least one receiving communication partner upon the setup of the communication connection, i.e. in particular before and/or upon the establishment of the communication connection.

Another embodiment of the invention provides that the at least one contact information to be communicated to the at least one receiving communication partner will be determined by an unequivocal identifier of the communication partner initiating the communication connection in the communication network and/or by an unequivocal identifier of the at least one receiving communication partner in the communication network. Advantageously, the unequivocal identifier of the communication partners in the communication network is a phone number in a telecommunication network, preferably a MSISDN (MSISDN: Mobile Subscriber ISDN; ISDN: Integrated Services Digital Network) in a mobile network according to a GSM, GPRS and/or UMTS radio network standard (GSM: Global System for Mobile Communications; GPRS: General Packet Radio Service; UMTS: Universal Mobile Telecommunications System).

Another advantageous embodiment of the invention provides that the at least one contact information comprises multimedia contents, preferably text, photography, graphics, animations, audio and/or video and/or information with respect to the whereabouts and/or the reachability of the communication partner initiating the communication connection in the communication network. Altogether the extend as well as the individuality of the use of the contact information can be further improved thereby.

In another advantageous embodiment of the invention the at least one contact information will be reproduced in the context of the communication connection at least by a terminal used by the at least one receiving communication partner for the communication connection, which terminal is usable in the communication network.

Advantageously, the at least one contact information will be memorized by means of a terminal used by the at least one receiving communication partner for the communication connection, which terminal is usable in the communication network. Herein, the memorization will be advantageously realized by a memorizing means of the terminal which is provided for this.

An especially advantageous embodiment of the invention is characterized in that the at least one contact information can be managed by the communication partner initiating the communication connection via a platform that is accessible in a communication network, preferably the internet. According to the invention, the respective user is thus enabled to realize an especially simple and extensive adjustment, maintenance and/or attendance of contact information.

The above mentioned aim is also technically achieved by the invention in that furthermore a terminal for the use in a communication network, preferably a mobile network according to a GSM, GPRS and/or UMTS radio network standard is proposed, which terminal is designed and/or adapted to at least partially carry out a method according to the invention.

Furthermore, the initially mentioned aim is achieved by the invention in that a network node in a communication network, preferably a mobile network according to a GSM, GPRS and/or UMTS radio network standard is proposed, which node at least contributes to the establishment, the holding and/or the disconnection of the communication connection and is designed and/or adapted to at least partially carry out a method according to the invention.

### BRIEF DESCRIPTION OF THE DRAWINGS

Further details, characteristics and advantages of the invention will be explained in detail in the following by means of the exemplary embodiments represented in the figures of the drawing. Herein:

FIG. 1 is a schematic diagram that shows the determination and reproduction of contact information of a communication partner in the context of a communication connection between two communication partners in a mobile network according to the state of the art and

FIG. 2 is a schematic diagram that shows an exemplary embodiment of a determination and reproduction according to the invention of contact information of a communication partner in the context of a communication connection between two communication partners in a mobile network.

### DETAILED DESCRIPTION OF THE INVENTION

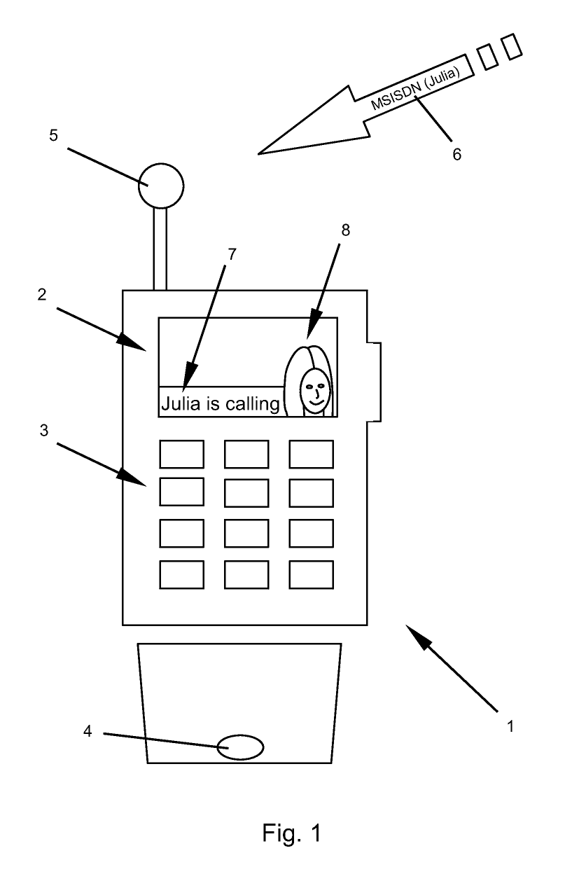

FIG. 1 shows a mobile terminal 1 that can be operated in a mobile network according to a GSM, GPRS and/or UMTS radio network standard, in the present case in form of a mobile phone 1, of a communication partner. The mobile phone 1 comprises a display unit 2 for the visual reproduction of information and/or signals. Herein, the display unit 2 has the form of a display 2. For gathering information and/or signals the mobile phone 1 comprises an entry unit 3 in the form of a keyboard comprising several keys as well as an entry unit 4 in the form of a microphone. Information and/or signals can be gathered or entered via the keys of the keyboard of the entry unit 3 by pressing the keys. Via the microphone 4 of the entry unit 4 information and/or signals can be gathered or entered by means of voice entries. In the context of a communication connection the mobile phone 1 receives and/or sends voices and/or data via the antenna 5 of a here no further represented sending/receiving unit of the mobile phone 1.

In the exemplary embodiment represented in FIG. 1 the mobile phone 1 is the mobile phone 1 of a receiving communication partner who receives voices and/or data in the context of a communication connection from a communication partner initiating the communication connection, in the present case “Julia”. The reception of voices and/or data by means of the mobile phone 1 of the receiving communication partner is symbolically represented in FIG. 1 by the arrow referenced by the reference numeral 6. Herein, the MSISDN of Julia (MSISDN (Julia)) is transmitted as Julia's contact information in the context of the communication connection to the receiving communication partner or his mobile phone 1 as switching feature of performance of the mobile network, in the present case for example by means of the switching feature of performance Clip. By means of the mobile phone 1 the receiving communication partner has deposed in the mobile phone 1 of the receiving communication partner for Julia's MSISDN and for the communication connection that the name of the other communication partner, in the present case of the communication partner initiating the communication connection, as well as also an image of the corresponding communication partner will be reproduced. Accordingly, in the present case the name of the communication partner initiating the communication, i.e. in the present case “Julia”, is reproduced in a display area 7 by means of the display unit 2 of the mobile phone 1 and also an image of “Julia” is reproduced in another display area 8 of the display unit 2 of the mobile phone 1. In the embodiment known in the state of the art the corresponding contact information of the communication partner initiating the communication connection, i.e. in the present case “Julia”, which information is reproduced or is to be reproduced by means of the display unit 2 of the mobile phone 1, has been deposed by means of the mobile phone 1 by the receiving communication partner using the mobile phone 1. Herein, the receiving communication partner has himself selected and predetermined the contact information of the communication partner initiating the communication connection that has to be reproduced by the display unit of the mobile phone 1.

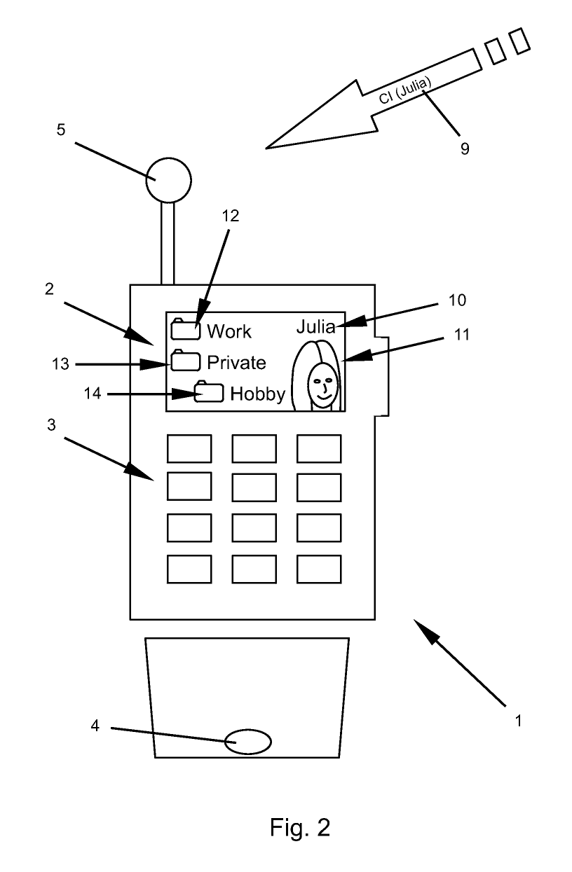

In the exemplary embodiment of the invention represented in FIG. 2 the mobile phone 1 of the receiving communication partner receives contact information (CI (Julia)) of the communication partner initiating the communication connection, in the present case of “Julia”, in the context of a communication connection via the antenna 5 of the sending/receiving unit of the mobile phone 1. Herein, the corresponding contact information (CI (Julia)) is transmitted to the mobile phone 1 in the context of the communication connection before and/or upon establishment of the communication connection. The transmission of the contact information (CI (Julia)) of the communication partner initiating the communication connection is symbolically represented in FIG. 2 by the arrow referenced by the reference numeral 9. The correspondingly transmitted contact information CI (Julia) is reproduced by the display unit 2 of the mobile phone 1 in different display areas. In the present case the contact information CI (Julia) comprises apart from the name of the communication partner initiating the communication connection, in the present case “Julia”, an image of the same one as well as information with respect to the work or the working place (“work”), private information (“private”) as well as leisure interests (“hobby”). Herein, the information accordingly reproduced by means of the display unit 2 of the mobile phone 1 in the display areas referenced by the reference numerals 10 through 14 of the display unit 2, i.e. in the present case name (10), photo (11), work (12), private (13) and leisure interests/hobby (14) are predetermined with respect to the information by the communication partner initiating the communication connection himself, thus in the present case “Julia”. Herein, the predetermination of the contact information (CI (Julia)) can, if required, even comprise the predetermination of the display area by the display unit 2 of the mobile phone of the receiving communication partner.

The contact information of the communication partner initiating the communication connection that is transmitted in the context of the communication connection to the receiving communication partner is managed by the communication partner initiating the communication connection preferably via a platform that is accessible in the internet. In the context of the communication connection the corresponding contact information (CI (Julia)) of the communication partner initiating the communication connection is then fetched from the platform via the mobile network and transmitted to the mobile phone 1 of the receiving communication partner via a network node of the mobile network. In another embodiment of the invention the corresponding contact information (CI (Julia)) of the communication partner initiating the communication connection is gathered, edited and/or managed by the same one by means of his own mobile terminal that can be operated in the mobile network and is correspondingly transmitted in the context of the communication connection from the mobile terminal of the communication partner initiating the communication connection to the mobile phone 1 of the receiving communication partner.

In another alternative and/or complementary embodiment of the invention, the contact information (CI (Julia)) of the communication partner initiating the communication connection is determined by a data source gathering information about the communication partner initiating the communication connection and transmitted to the receiving communication partner. Herein, the data source can be implemented as a service which collects information about or of a certain person as communication partner and correspondingly makes it available to the receiving communication partner. Herein, the information source can be for example a website in the internet, a directory or a like information source specified by the respective user.

The exemplary embodiments of the invention represented in the figures of the drawings and described in connection with these ones only serve for explaining the invention and are not limiting for this one.

1. A method for the at least partially automatic determination of contact information of at least one communication partner in the context of a communication connection between at least two communication partners in a communication network, wherein at least one contact information of the communication partner initiating the communication connection is communicated to the at least one receiving communication partner, characterized in that the at least one contact information is predetermined by the communication partner initiating the communication connection.

2. The method according to claim 1, characterized in that the at least one contact information of the communication partner initiating the communication connection will be managed by a data base gathering contact information.

3. The method according to claim 2, characterized in that the data base is provided by a switching device of the communication network that contributes to the communication connection and/or is involved in the communication connection and/or by a terminal used by the communication partners for the communication connection and usable in the communication network.

4. The method according to claim 1, characterized in that the at least one contact information will be communicated to the at least one receiving communication partner upon the setup of the communication connection.

5. The method according to claim 1, characterized in that the at least one contact information to be communicated to the at least one receiving communication partner will be determined by an unequivocal identifier of the communication partner initiating the communication connection in the communication network and/or by an unequivocal identifier of the at least one receiving communication partner in the communication network.

6. The method according to claim 5, characterized in that the unequivocal identifier of the communication partners in the communication network is a phone number in a telecommunication network, preferably a MSISDN in a mobile network according to a GSM, GPRS and/or UMTS radio network standard.

7. The method according to claim 1, characterized in that the at least one contact information comprises multimedia contents, preferably text, photography, graphics, animations, audio and/or video and/or information with respect to the whereabouts and/or the reachability of the communication partner initiating the communication connection in the communication network.

8. The method according to claim 1, characterized in that the at least one contact information will be reproduced in the context of the communication connection at least by a terminal used by the at least one receiving communication partner for the communication connection, which terminal is usable in the communication network.

9. The method according to claim 1, characterized in that the at least one contact information will be memorized by means of a terminal used by the at least one receiving communication partner for the communication connection, which terminal is usable in the communication network.

10. The method according to claim 1, characterized in that the at least one contact information can be managed by the communication partner initiating the communication connection via a platform that is accessible in a communication network, preferably the internet.

11. A terminal for the use in a communication network, preferably a mobile network according to a GSM, GPRS and/or UMTS radio network standard, characterized in that said terminal is designed and/or adapted to at least partially carry out a method according to claim 1.

12. A network node in a communication network, preferably a mobile network according to a GSM, GPRS and/or UMTS radio network standard, which node at least contributes to the establishment, the holding and/or the disconnection of the communication connection, characterized in that said node is designed and/or adapted to at least partially carry out a method according to claim 1.
